(19) United States
(12) Patent Application Publication
(10) Pub. No.: US 2006/0098363 A1
(43) Pub. Date: May 11, 2006

(54) Integrated transient blocking unit compatible with very high voltages

(75) Inventors: Francois Hebert, San Mateo, CA (US); Richard Harris, Palo Alto, CA (US)

Correspondence Address: GROOVER & HOLMES, BOX 802889, DALLAS, TX, 75380-2889, US

(73) Assignee: Fultec Semiconductors, Inc.

(21) Appl. No.: 11/130,829

(22) Filed: May 17, 2005

Related U.S. Application Data
(60) Provisional application No. 60/626,369, filed on Nov. 9, 2004.

(51) Int. Cl. H02H 9/00

(52) U.S. Cl. 361/56

(57) ABSTRACT

A transient blocking unit (TBU) with integrated over-current protection and discrete over-voltage protection. In one example embodiment, the present innovations are embodied as a unit for protecting a circuit from high voltage and high current, comprising a core transient blocking unit with at least one high voltage device wherein the core transient blocking unit is integrated, and wherein the at least one high voltage device is discrete.

### CROSS-REFERENCE TO OTHER APPLICATIONS

This application claims priority from U.S. provisional Application 60/626,369 filed Nov. 9, 2004, which is hereby incorporated by reference.

### BACKGROUND AND SUMMARY OF THE INVENTION

1. Field of the Invention

The present invention relates to surge protecting circuits, and more specifically to transient blocking units suitable, for example, for telecommunications and power applications.

2. Background

Surge protection is an important element to many electrical systems, particularly for telecom, data applications and other sensitive systems such as high frequency coaxial lines. Lightning and other power events can induce sudden electrical surges or transients. Such events can damage or destroy sensitive electrical equipment. Effective systems which protect against such surges are available, but have serious drawbacks in terms of effectiveness, reliability, complexity and reduction in bandwidth.

One form of protection device is known as a polymer PTC or positive temperature coefficient resistor/thermistor. In its normal state, the material in the PTC is in the form of a dense solid, with many carbon particles packed together to form conductive pathways of low resistance. When the material is heated from excessive current, the polymer expands, pulling the carbon chains apart and greatly increasing the resistance. Such devices remain in the tripped or open state until the voltage is removed and the temperature decreases.

Another type of circuit protection is the transient blocking unit, or TBU. Like a PTC, the TBU works to become an effective open circuit in response to excessive line current. TBUs typically have a much faster response time than PTCs. Unlike the PTCs, TBUs are stable, and do not drift or shift in performance after transient events. Typical TBUs do not require a power source and do not limit circuit bandwidth.

FIG. 1 shows a prior art TBU, which can protect a load from voltage and/or current transient spikes or surges. In this example, the protection circuit is a unidirectional device, and is shown with an n-channel depletion mode device 102 and a p-channel depletion mode device 104. Depletion mode devices have a low on-resistance when the voltage difference between gate and source (V_{gs}) is equal to zero, and are turned off by applying a negative bias (for n-channel) or positive bias (for p-channel) on the gate (with respect to the device's source).

The n-channel device 102 is turned off by the voltage drop across the p-channel device 104. This voltage drop, shown as V_{gsp}, increases as the load current increases. As the n-channel device 102 is biased off, its resistance increases, which in turn increases the voltage drop across its drain and source. The p-channel device 104 then turns off since its gate is connected to the input terminal from where the transient is coming. The device depicted in FIG. 1 is a unidirectional device, meaning this circuit is designed to handle an input current surge of only one polarity. Bi-directional TBUs also exist which can protect against surges of both polarities, as depicted below.

FIG. 2 shows a prior art bi-directional TBU. This example shows two n-channel depletion mode devices 202 and 206 with a p-channel depletion mode device 204. Also shown are two sets of current limiter devices, which may include (but are not limited to) diodes, resistors, diode connected transistors, current sources, or a combination thereof 208, 210 placed between the gate of the p-channel device 204 and the loads at either end of this example bi-directional TBU. These devices 208, 210, when attached to the gate lead, reduce the need for a high gate breakdown voltage. The differences between p-channel and n-channel TBUs are discussed further below.

FIG. 3 shows an example prior art TBU, but with p-channel devices connected to the input terminals instead of n-channel devices. This device functions similarly to that of FIG. 2 except for the obvious differences in carrier type of the depletion mode devices 302 (which is p-channel in this example), 304 (which is n-channel in this example) and 306 (which is p-channel in this example). Also shown are diodes, resistors, or combinations thereof 308, 310.

The example of FIG. 2, showing n-channel devices connected to the input terminals, is generally considered the most efficient for several reasons. For example, the device connected to the input is used to block high voltage transient once the TBU is turned off, which requires the input device to have a high breakdown voltage while having a low series resistance, low cost, and small size. N-channel devices have lower resistance than p-channel devices because of the differences between electron and hole mobility. N-channel devices are also preferred because low resistance, high breakdown voltage devices are more commonly available as n-channel than as p-channel.

The above example TBUs may not be ideal for high voltage applications, and do not necessarily provide suitable transient protection under high voltage conditions. FIG. 4 shows an example prior art high voltage TBU, which enhances the maximum voltage of the TBU circuit by adding high voltage n-channel devices at the input and/or output (depending on whether the device is uni-directional or bi-directional). In this example, the TBU of FIG. 2 has been modified by the addition of two high voltage n-channel depletion mode devices, one at the input (for example, in a uni-directional or bi-directional unit) and one at the output (in bi-directional units only). In this example, two n-channel depletion mode devices 402, 406 are implemented with a p-channel depletion mode device 404. Current limiting devices, 408, 410, are again used to bias the p-channel devices. FIG. 4 also shows high voltage n-channel depletion mode devices 412, 414 at either end of the TBU. The addition of n-channel depletion mode devices 412, 414 serves to enhance the maximum blocking capability of the TBU.

A TBU is preferred to have a low series resistance and to have a low voltage drop across its elements. It should be of low cost and small size, and be compatible with high volume manufacturing processes, such as semiconductor fabrication. TBUs are preferably robust and have high reliability and repeatable trip currents, such that there is little or no drift or shift after multiple events. Finally, TBUs are preferably resettable or recover automatically after a surge is experienced.

As mentioned above, TBUs may be integrated to reduce the number of components and size, and simplify the assembly and use of the circuits. For example, we hereby incorporate by reference PCT 00AU2004/00117. The most significant compromise is between resistance, blocking voltage and TBU sensitivity. In order for a TBU to be practically useful it must be capable of blocking practical surge voltages (which are often in excess of 500 volts). In addition, ideally the TBU would have no resistance so it places no load on a circuit it is placed to protect. Unfortunately, high voltage devices of low resistance are expensive to manufacture, especially to the level of accuracy to make a sensitive TBU able to react to very small current.

There are many challenges remaining in this area of technology. For example, combining high voltage, sensitivity, low resistance, low cost and small size in one component remains difficult. Low resistance, high sensitivity and high voltage all require the use of larger devices, while low cost suggests the use of small die sizes. These challenges are magnified when components of different voltage ranges are combined in one die because of the difficulties in optimization.

Further information can be found in various references, including application number PCT/AU03/00175, and PCT/AU03/00848 and U.S. Pat. No. 5,742,463 to inventor Richard Harris, which are hereby incorporated by reference.

Integrated Transient Blocking Unit Compatible with Very High Voltages

The present innovations include a new approach which achieves an efficient integration of the core elements of a TBU while maintaining some discrete elements in order to alleviate some of the compromises necessary in other TBU circuits. In one example embodiment, the present innovations are embodied as a unit for protecting a circuit from high voltage and high current, comprising a core transient blocking unit (aka a current sense portion, preferably comprising a plurality of components that together realize a current sense function) with at least one high voltage device wherein the core transient blocking unit is integrated, and wherein the at least one high voltage device is discrete. Other embodiments, including systems and methods, are described more fully below.

Advantages of various embodiments described herein include one or more of the following, which are categorized broadly as ease and cost of manufacturing; mix and match functionality; and better matching of the devices in order to improve the symmetry of the circuit, particularly in the bi-directional version.

For example, by disconnecting the sensitivity requirements of the TBU from the high voltage devices the core can be efficiently manufactured using suitable processes in a suitable LV (low voltage) fabrication facility (“fab”), while the high voltage devices can be manufactured at a suitable high voltage process fab. Removing all sensitive specifications from the HV devices allows them to be built quickly and with wide tolerance on specific requirements, such as alleviating the need for a low pinch-off voltage. Core performance capability is also able to be mixed and matched for applications with high voltage performance needs. The innovations also provide a low cost core TBU with precise control and repeatability of the trip current.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 shows a prior art protection circuit.

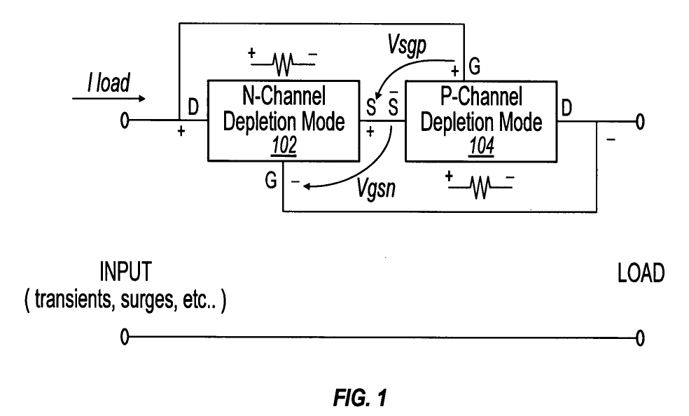

FIG. 2 shows a prior art protection circuit using diodes, resistors, or a combination thereof.

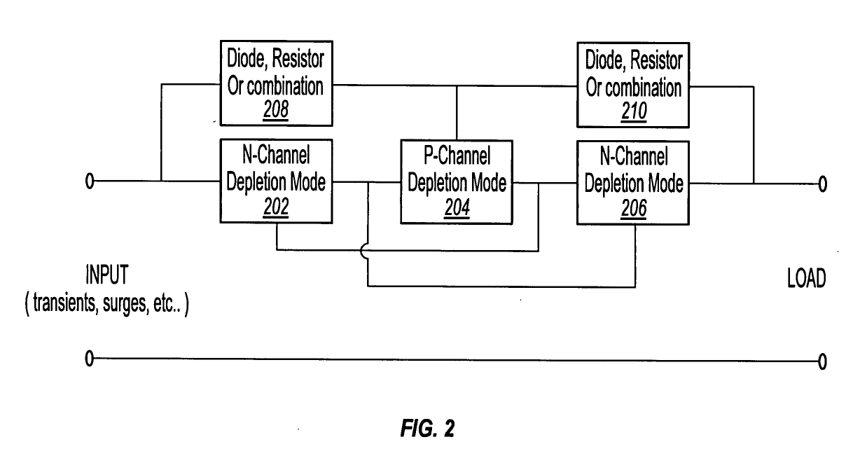

FIG. 3 shows a prior art protection circuit with two p-channel devise as input and output.

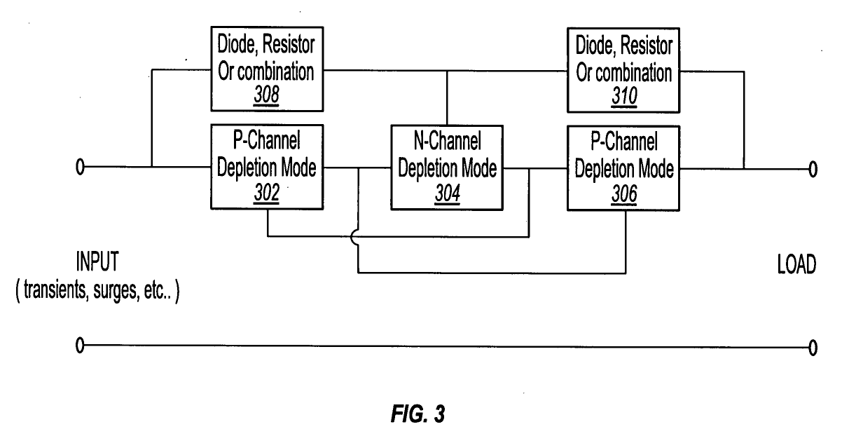

FIG. 4 shows a prior art higher voltage protection circuit.

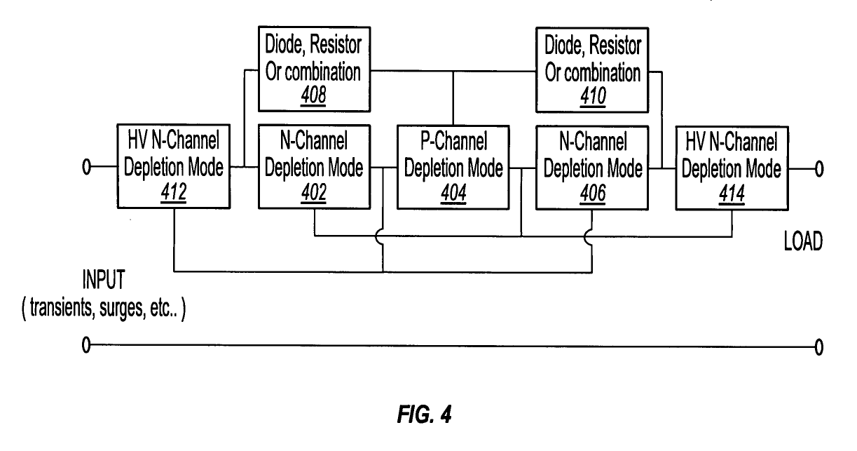

FIG. 5 shows a core TBU-only integrated protection circuit according to a preferred embodiment of the present invention.

FIG. 6 shows a core TBU-only integrated protection circuit according to a preferred embodiment of the present invention.

FIG. 7 shows a core TBU according to a preferred embodiment of the present invention.

FIG. 8 shows a unidirectional core TBU according to a preferred embodiment of the present invention.

FIG. 9 shows a process option for a merged structure according to a preferred embodiment of the present invention.

FIG. 10 shows a process option for a merged structure according to a preferred embodiment of the present invention.

FIG. 11 shows a cellular structure for a merged structure TBU according to a preferred embodiment of the present invention.

FIG. 12 shows a multi-cell implementation of a TBU structure according to a preferred embodiment of the present invention.

FIG. 13 shows an implementation of a TBU with larger cell size according to a preferred embodiment of the present invention.

FIG. 14 shows a non-merged structure of a TBU according to a preferred embodiment of the present invention.

FIG. 15 shows a uni-directional merged structure according to a preferred embodiment of the present invention.

FIG. 16A shows a prior art protection circuit.

FIGS. 16B, 16C, and 16D show TBUs according to preferred embodiments of the present invention.

### DETAILED DESCRIPTION OF THE PREFERRED EMBODIMENTS

The numerous innovative teachings of the present application will be described with particular reference to the presently preferred embodiment (by way of example, and not of limitation).

The present innovations include a new approach which achieves an efficient integration of the core elements of a TBU while maintaining partition between elements in order to alleviate some of the compromises necessary in other TBU circuits. For example, in one preferred embodiment, the entire TBU is not integrated in one die. The low-voltage devices of the TBU are integrated to form a low cost core TBU with precise control and repeatability of the trip current for consistent, robust, and reliable over-current protection. The high voltage input and/or output devices (depending on whether the TBU is uni-directional or bi-directional) are separately added, for example, as discrete devices.

Thus, a preferred embodiment of the present inventions separates the over-current and over-voltage protection functions. The core TBU (which is preferably integrated) carries out the over-current protection, so that the devices integrated in the core TBU do not require a high breakdown voltage. Discrete input devices carry out the over-voltage protection. Since the over-current function is carried out by the core-TBU, the high voltage devices do not require a low pinch-off voltage. This relaxes the requirement on the high voltage input and/or output devices.

Since the gate of the p-channel device is connected to the input terminal, the gate breakdown voltage (BV_{gss}, for example) of the p-channel device must be as high as the maximum input voltage. This places limitations on the operating conditions, or on the selection of the p-channel devices. By adding a current source or resistor in the gate lead (for example, see PCT/AU03/00175, referenced above), the need for a high gate breakdown voltage is reduced.

Since the TBU trip trigger current is the turnoff point for the n-channel device, the resistance of the p-channel device is important. Trip current multiplied by the p-channel resistance should, in one example, equal the pinch-off of the n-channel device. The pinch-off voltage of the p-channel device should be higher than that of the n-channel device to ensure reliable trip current. Therefore, the p-channel device is preferably a depletion mode device, either MOSFET or JFET, with a Rdson value based on the desired TBU trip current and a pinch-off voltage higher than that of the n-channel device. The ideal low-cost device for such an application is the PJFET.

The n-channel device is preferably a depletion mode device, with a low pinch-off voltage and a high breakdown voltage. As for the p-channel device, the JFET structure (or SIT for example) is well suited for the application, except for the low pinch-off voltage requirement. JFETS typically have high and more variable pinch-off voltages.

Integration of a TBU means reducing the size and cost of the circuits and systems, and increasing the performance and reliability. In the case of a TBU circuit, full and complete integration would result in the need to combine very high voltage “input devices” with the internal n- and p-channel devices, as described above. Integrating a bi-directional TBU would preclude the use of vertical n-channel MOSFETs since these structures use the N+ substrate as the drain connection, and the bi-directional TBU requires two isolated drains. Lateral devices can achieve very high breakdown voltages, but they require a large active area. Therefore, the present innovations have been developed to address these conflicting needs.

In one example embodiment, the breakdown voltage of the core portion is preferably higher than the maximum pinch-off voltage specified for the depletion mode HV device used as input and/or output. The core voltage can be, in one set of example embodiments, in the range of 3V to 100V, with a preferred range near 40V. The pinch-off voltage of the high voltage devices (again, preferably used as input and/or output for the core) can be 1V to 3V for some commercially available SiNMOS depletion mode devices, and can be 5V to 40V for some SiNMOS devices optimized for protection applications. Other types of devices can range even higher, such as Silicon Carbide Vertical JFET devices. These ranges are not intended to limit the scope of the present innovations, but are provided only to give numeric estimates of some examples.

The breakdown voltages of the HV devices can be in the 100V to 1400V range, for example, with silicon, and can range even higher (e.g., 600V to 5 kV) for some devices, such as silicon carbide devices.

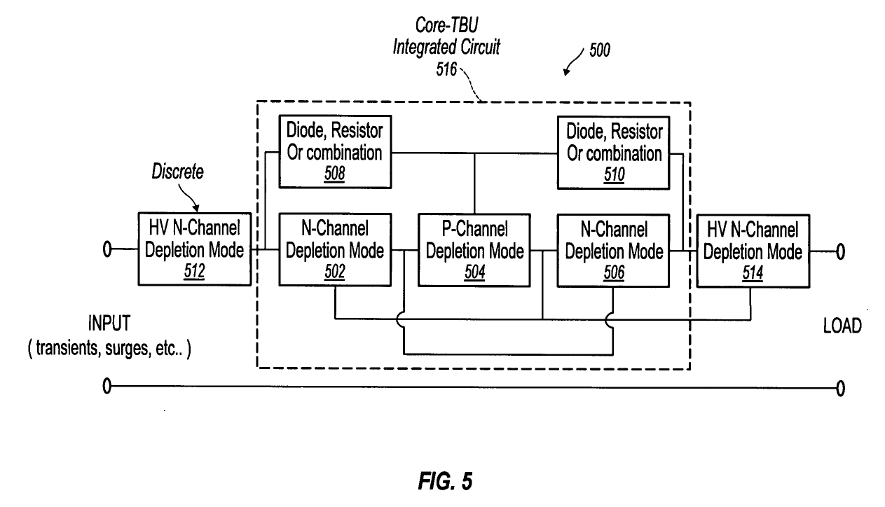

FIG. 5 shows an innovative circuit consistent with a preferred embodiment of the present invention. In this example implementation, an integrated core TBU 516 is depicted with discrete high voltage circuit or circuits 512, 514 which are separate from the over-current functions.

This example embodiment depicts two n-channel depletion mode devices 502, 504 as the input and output of the integrated core TBU 516. A p-channel depletion mode device 504 is connected by the gate lead to (in this bi-directional example) two sets of diode, resistor, or some combination thereof 508, 510. This integrated core TBU performs over-current protection, but not over-voltage protection. Two n-channel high voltage depletion mode devices complete the protection circuit by adding over-voltage protection.

Thus, in this example embodiment, the maximum voltage of the TBU circuit is enhanced by adding the high voltage n-channel depletion mode devices at the input (uni- or bidirectional) and output (bidirectional only). The maximum gate voltage applied to the p-channel device is reduced by the blocking action of the high voltage n-channel depletion mode devices.

The breakdown voltage is a function of the maximum pinch-off voltage of the HV input devices. Typical pinch-off of high voltage NJFET or NSIT device is in the 15-20 volt range, and the breakdown voltage of the NMOS device within the core should therefore be in the 35-40 volt range.

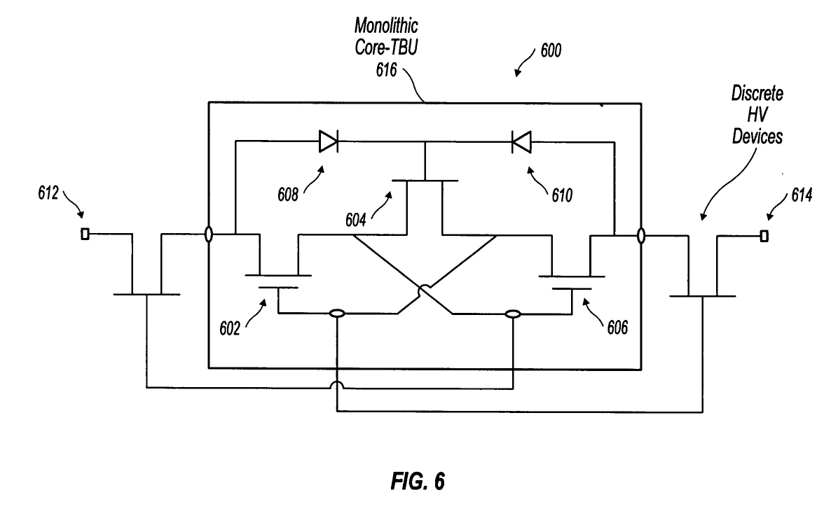

Trigger current is the pinch-of voltage of the NMOS device divided by the on resistance of the PJFET device, as described below with respect to FIG. 6. The present inventions include the concept for a core TBU which includes all of the necessary devices to perform fast and accurate over-current protection. FIG. 6 shows the monolithic core TBU 616 with a PJFET 604 and two NMOS devices 602, 606. This depiction includes high voltage devices 612, 614 are also shown as discrete additions to the integrated core TBU. The PJFET 604 provides the voltage drop necessary to turn off the NMOS devices 602, 606. The maximum voltage requirements are set by the pinch-off voltage of the high voltage (HV) input device or devices.

This results in relaxed requirements for the HV devices. Particularly they no longer require low pinch-off voltage since this function is in the low voltage core TBU circuit. This has the effect of minimizing overall cost and makes for a flexible protection circuit. The core TBU circuit can be used with any high voltage input devices (since the HV devices are not integrated in preferred embodiments). Any type of input/output devices can be used, such as JFET, SIT, or MOSFETs. Further, any material can be used, such as Si or SiC. Finally, the performance of the HV devices is not compromised.

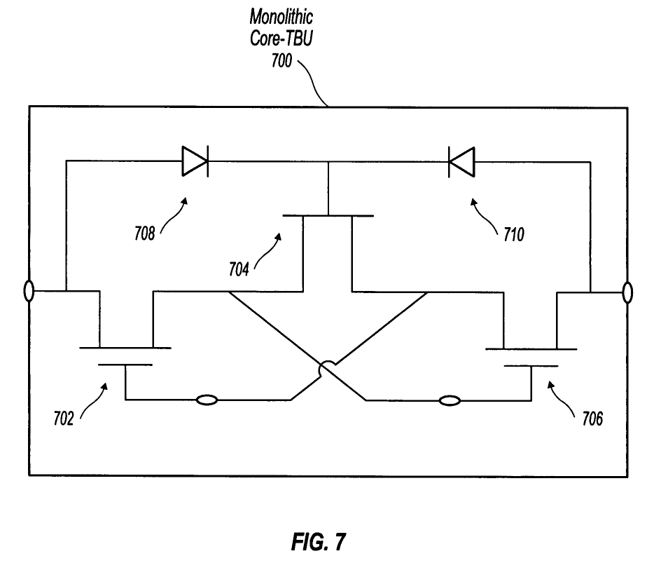

FIG. 7 shows an embodiment of the core TBU 700. This embodiment uses a JFET for the p-channel device 704 and MOSFETS for the n-channel devices 702, 706. In this example, a bi-directional implementation, diodes 708, 710 are used in the gate connection of the JFET to avoid shorting the input to the output. Of course, FIG. 7 is only one example, and other implementation are possible and within the scope of the present invention, such as a replacement of NJFETs instead of NMOS devices.

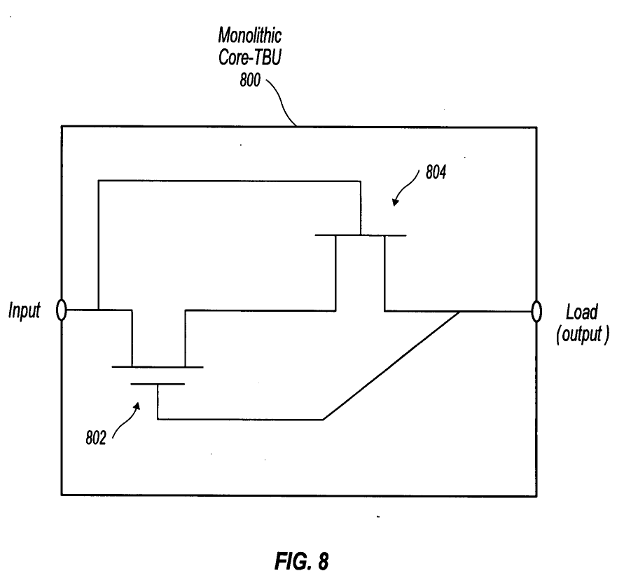

FIG. 8 shows another embodiment of the core TBU 800. In this example, a uni-directional implementation, an NMOS 802 and a PJFET 804 are shown. This, like other preferred embodiments, shows that the core TBU 800 is monolithic.

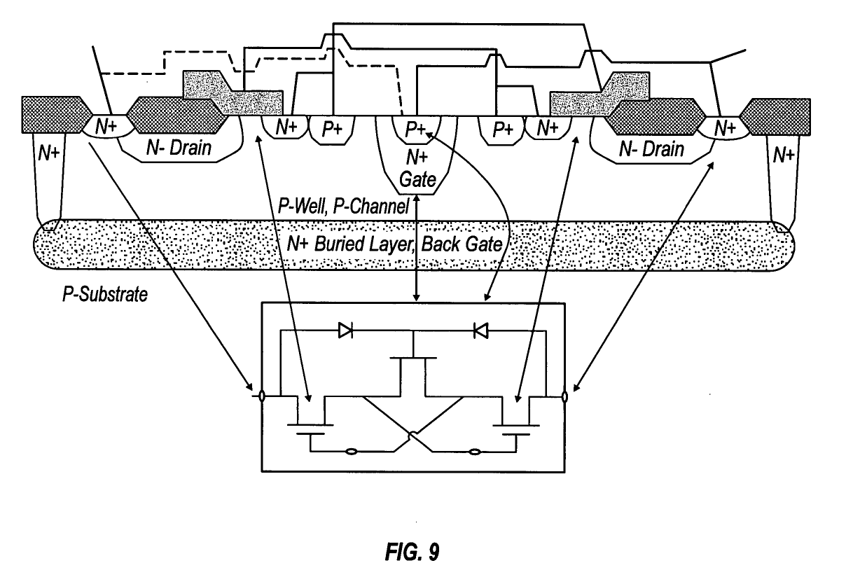

The present innovations can be implemented using a variety of semiconductor processing options. For example, FIG. 9 shows one example embodiment that has small structure, high packing density, and low cost. In this example, the embodiment is based on an integrated merged structure. A bi-directional version is shown. This example shows a P-substrate, and N+ buried layer, and a P-diffusion or P-epi layer for the JFET cannel and NMOS body.

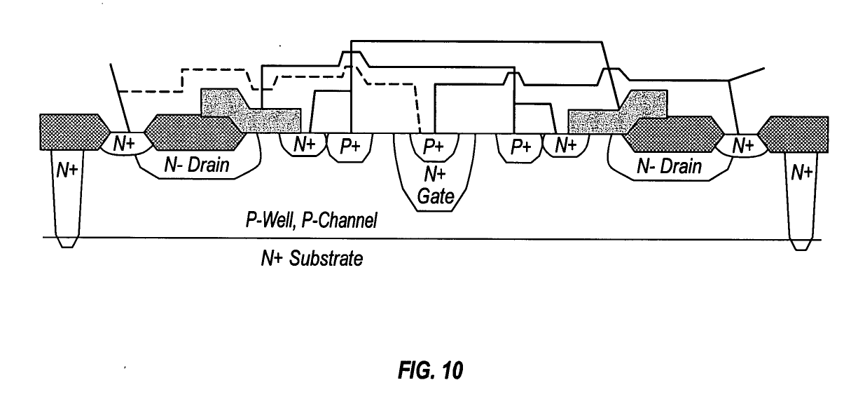

FIG. 10 shows another view of the structure of an embodiment of the present invention. This example is contrasted with that of FIG. 9 to show that there are several process options that do not alter the circuit, including the use of an N+ substrate with a P-diffusion or P-epi layer. Preferred embodiments can also use -epi with a diffused P-well for the NMOS body and PJFET channel, or P-type epi. The approach shown in FIG. 10 is low cost since there is no buried layer. It is compatible with standard P-channel discrete JFET manufacturing processes. The NMOS process options include, for example, drain extension with N-field type diffusion implanted prior to LOCOS field oxidation, self-aligned to active region. Double diffused drain or drift drain are also options. The drain extension doping and length vary with target voltages of the devices.

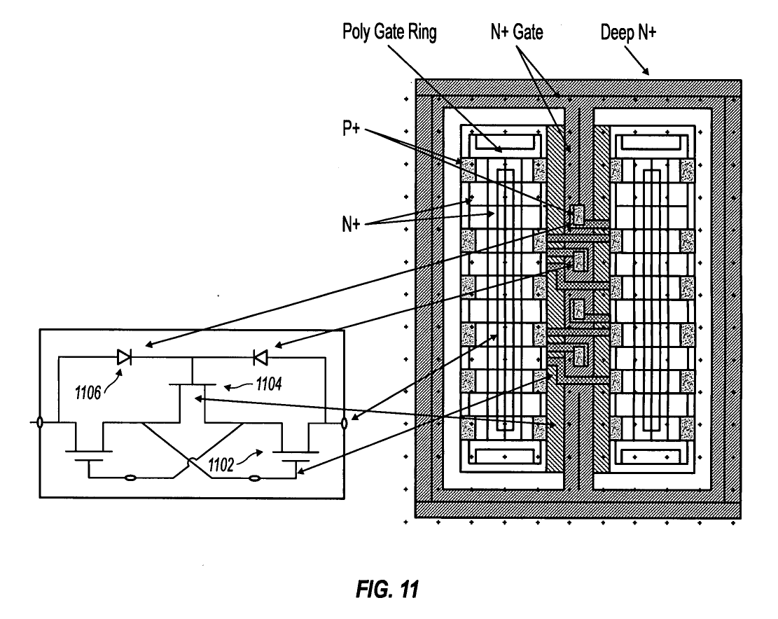

FIG. 11 shows another view of the merged core TBU with cellular structure. This figure depicts a bi-directional version, shown with a single drain finger for the NMOS 1102 and a single gate finger for the PJFET 1104. It is noted that in this embodiment, a diode 1106 is located inside the gate finger of the PJFET, and the PJFET is between fingers of the adjacent NMOS devices.

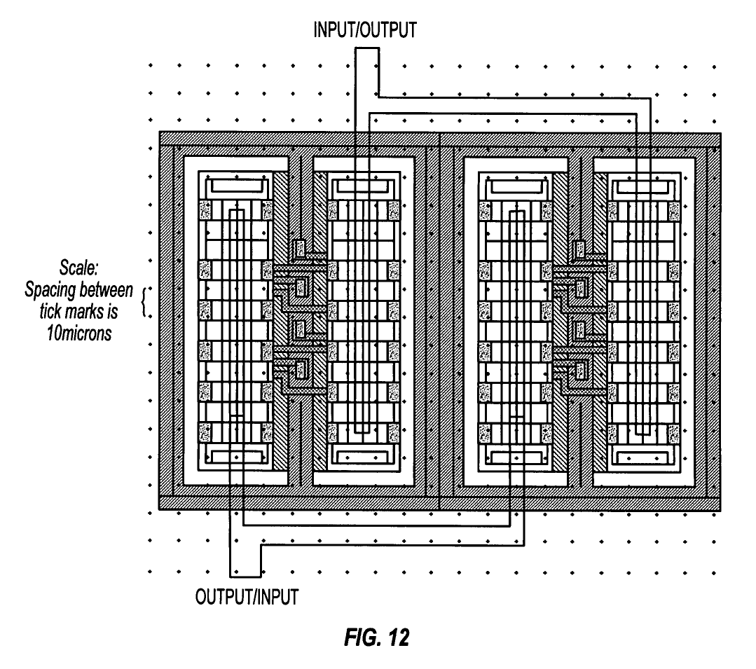

Multiple cells can be used for lower resistance and higher current levels. FIG. 12 shows an example of such an implementation. A bi-directional version is shown, including a double drain finger for NMOS and triple gate finger for the PJFET.

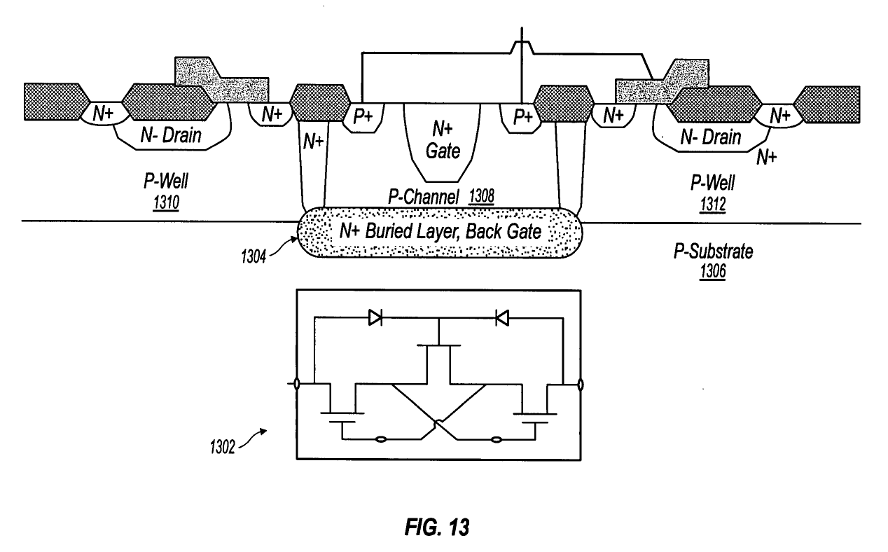

FIG. 13 shows another example embodiment, this one based on an implementation of the TBU circuit 1302 that has a larger cell size and higher cost, but which also has higher flexibility. This example includes an N+ buried layer 1304 in a P-substrate 1306 and a P-channel 1308 and two P-wells 1310, 1312.

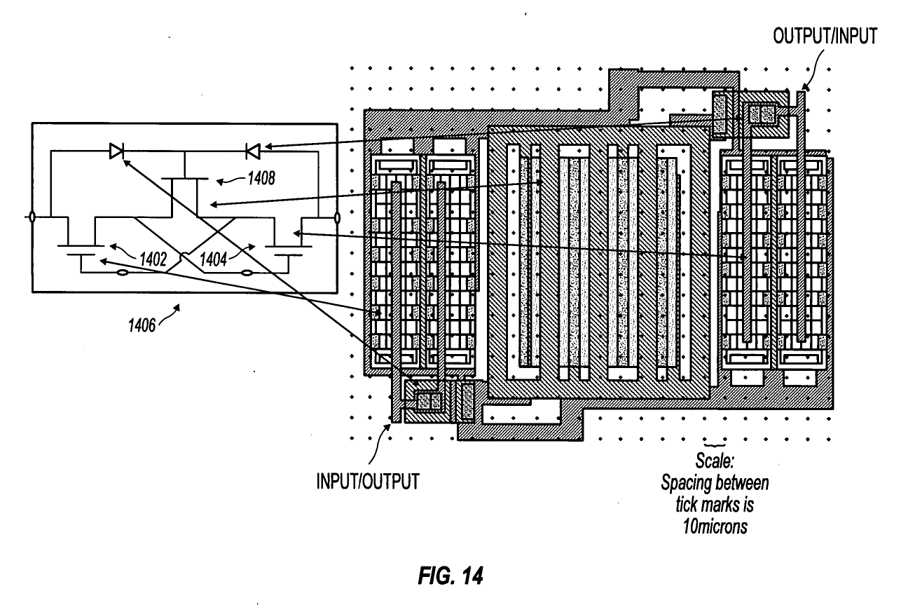

FIG. 14 shows a non-merged structure. The non-merged implementation is about 30% larger than the merged structure described above. The non-merged structure has the same effective gate width as in the merged scheme. This example shows two drain fingers per NMOS 1402, 1404 of the TBU 1406 and three gate fingers for the PJFET 1408.

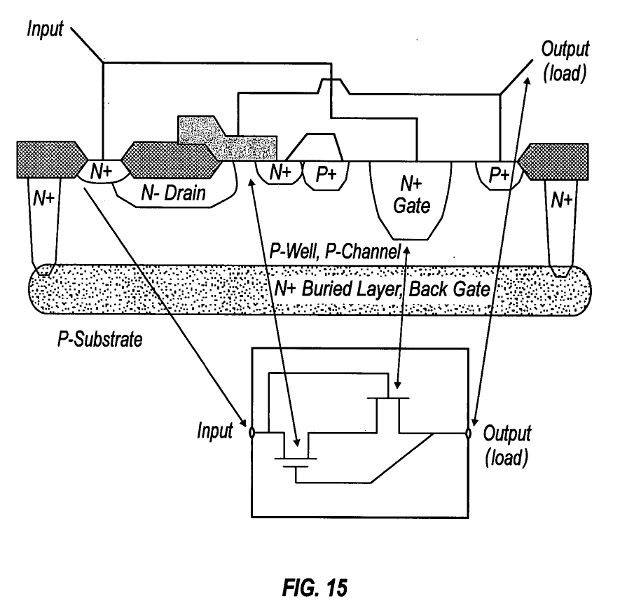

FIG. 15 shows a uni-directional example using a merged structure. This example embodiment includes an N+ buried layer, and P-well and P-channel.

The fully integrated bi-directional TBU of the present inventions can be achieved, for example, by using either a single NMOS approach or a dual NMOS approach (or alternately using PMOS devices, though such embodiments are less preferred). The dual NMOS approach as the benefit of relaxed HV transistor requirements. The dual NMOS approach also has the drawback of higher potential resistance since there are more devices in the signal path.

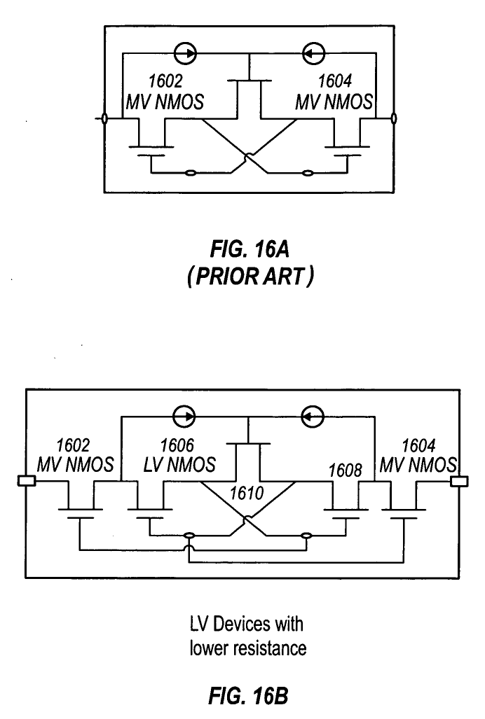

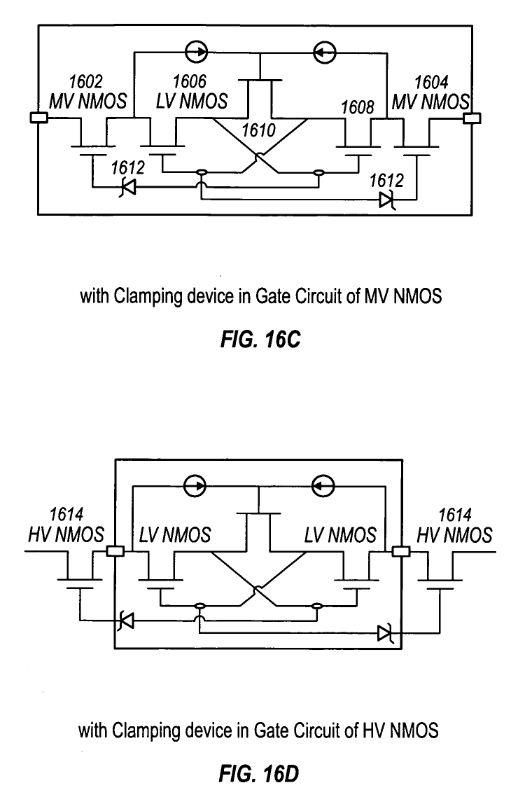

FIG. 16A shows a prior art TBU circuit with MV NMOS devices 1602, 1604, implemented in a bi-directional circuit protection circuit. Note the difference between FIGS. 16A and 16B. The innovative embodiment shown in FIG. 16B is a version which is compatible with HV devices having a pinch-off voltage hither than that of the PJFET. FIG. 16C is an embodiment that is consistent with HV devices of any pinch-off voltages, as described below.

FIG. 16B shows an embodiment of the present innovations wherein MV NMOS devices 1602, 1604 are integrated with LV NMOS devices 1606, 1608 to take advantage of the low resistance achieved by the LV technology. By using this configuration, the MV NMOS devices 1602, 1604 can have a wide range of pinch-off voltages higher than that of the LV NMOSFETs and the PJFET 1610 of this example.

If the MV NMOS has the similar pinch-off voltage as the LV NMOS device and lower than that of the PJFET 1610, the zener/avalanche diode 1612 in the gate connection of the MV device ensures that the internal portion of the core TBU (LV NMOSFETs and PJFETs) turns off first, as shown in FIG. 16C. Therefore, this TBU circuit will operate with MV NMOSFETs with virtually any practical pinch-off voltage. This embodiment makes for a highly manufacturable protector which maximizes yield, quality and minimizes cost.

FIG. 16D shows an innovative structure that includes a clamping device in the gate circuit of the HV NMOS devices 1614, which are positioned at the input and/or output of the TBU circuit. In this example, discrete HV NMOS devices 1614 are FETs having a lower pinch-off voltage than that of the LV devices in the integrated TBU. The integrated zener diodes ensure that the effective pinch-off of the HV FET is increased to a level higher than that of the PJFET device.

According to one embodiment, the present innovations are described as a method of making a surge protecting unit, comprising the steps of: fabricating a circuit having a plurality of low and/or medium voltage devices in an integrated circuit, the circuit having an input and an output; connecting at least one high voltage device to at least one of the input and output of the circuit; wherein the at least one high voltage device is partitioned from the circuit.

According to one embodiment, the present innovations are described as a surge protection system, comprising: a circuit having a plurality of low and/or medium voltage devices in an integrated circuit, the circuit having an input and an output; at least one high voltage device to at least one of the input and output of the circuit; wherein the at least one high voltage device is partitioned from the circuit.

According to one embodiment, the present innovations are described as a surge protection system, comprising: a protection circuit which provides over-current protection; at least one input device connected to the protection circuit, the at least one input device providing over-voltage protection; wherein the at least one input device is separated from the circuit.

According to one embodiment, the present innovations are described as a surge protection system, comprising: a circuit having a plurality of low and/or medium voltage devices in an integrated circuit, the circuit having an input and an output; at least one high voltage device operably connected to at least one of the input and output of the circuit; wherein the at least one high voltage device is partitioned from the circuit and made from a different semiconductor substrate than the core circuit.

According to one embodiment, the present innovations are described as a surge protection system, comprising: a protection circuit which provides over-current protection; at least one high voltage input device connected to the protection circuit, the at least one high voltage input device providing over-voltage protection; at least one gate voltage enhancement circuit in series with a gate of the high voltage input device; wherein the high voltage device is separated from the core.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

Modifications and Variations

As will be recognized by those skilled in the art, the innovative concepts described in the present application can be modified and varied over a tremendous range of applications, and accordingly the scope of patented subject matter is not limited by any of the specific exemplary teachings given.

For example, the present innovations can be implemented, consistent and within the scope of the concepts disclosed herein, using integrated HV devices on a bonded wafer, for example, using isolation techniques such as trenching between the devices for isolation.

Further, these innovative concepts are not intended to be limited to the specific examples and implementations disclosed herein, but are intended to include all equivalent implementations, such as (but not limited to) using different types of depletion mode devices (known or unknown at this time) or other devices to replace the example devices used to describe preferred embodiments of the present innovations. This includes, for example, changing the core in some minor way, such as by adding diodes (or replacing such devices with similar devices, such as current sources) or other devices.

Further, the present innovations are highly applicable to semiconductor materials other than the example of silicon given herein. For example, silicon carbide or GaN are idea for the medium or high voltage FET devices, as the concepts herein described are compatible with wide ranges of pinch-off voltages and the use of different substrates for components.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle. Moreover, the claims filed with this application are intended to be as comprehensive as possible: EVERY novel and nonobvious disclosed invention is intended to be covered, and NO subject matter is being intentionally abandoned, disclaimed, or dedicated.

What is claimed is:

1. A method of making a surge protecting unit, comprising the steps of:
fabricating a circuit having a plurality of low and/or medium voltage devices in an integrated circuit, the circuit having an input and an output;
connecting at least one high voltage device to at least one of the input and output of the circuit;
wherein the at least one high voltage device is partitioned from the circuit.

2. The method of claim 1, wherein the at least one high voltage device is fabricated in a separate process from the fabricating step of the circuit.

3. The method of claim 1, wherein the at least one high voltage device is a discrete device.

4. The method of claim 1, wherein the at least one high voltage device is partitioned from the circuit by trenching.

5. The method of claim 1, wherein the circuit is a bidirectional transient blocking unit.

6. The method of claim 5, wherein the at least one high voltage device comprises a first high voltage device connected to the input of the circuit and a second high voltage device connected to the output of the circuit.

7. A surge protection system, comprising:
a circuit having a plurality of low and/or medium voltage devices in an integrated circuit, the circuit having an input and an output
at least one high voltage device to at least one of the input and output of the circuit;
wherein the at least one high voltage device is partitioned from the circuit.

8. The system of claim 7, wherein the at least one high voltage device is fabricated in a separate process from the circuit.

9. The system of claim 7, wherein the at least one high voltage device is a discrete device.

10. The system of claim 7, wherein the at least one high voltage device is partitioned from the circuit by trenching.

11. The system of claim 7, wherein the circuit is a bi-directional transient blocking unit.

12. The system of claim 11, wherein the at least one high voltage device comprises a first high voltage device connected to the input of the circuit and a second high voltage device connected to the output of the circuit.

13. A surge protection system, comprising:
a protection circuit which provides over-current protection;
at least one input device connected to the protection circuit, the at least one input device providing over-voltage protection;
wherein the at least one input device is a high voltage device that does not share the same substrate as medium or low voltage devices of the protection circuit.

14. The system of claim 13, wherein the protection circuit has a breakdown voltage that is higher than the maximum pinch-off voltage of the at least one input device providing over-voltage protection.

15. The system of claim 13, wherein the at least one input device is a depletion mode device that has a pinch-off voltage that is higher than the pinch-off voltage of devices of the protection circuit.

16. The system of claim 13, wherein the at least one input device is a discrete device fabricated in a different process relative to the protection circuit.

17. The system of claim 13, wherein the protection circuit is a bi-directional transient blocking unit.

18. The system of claim 13, wherein the at least one input device comprises a first high voltage device connected to the input of the protection circuit and a second high voltage device connected to the output of the protection circuit.

19. The system of claim 13, wherein the protection circuit has a breakdown voltage substantially equivalent to the maximum gate drive required to turn off the high voltage device.

20. A surge protection system, comprising:
a circuit having a plurality of low and/or medium voltage devices in an integrated circuit, the circuit having an input and an output;
at least one high voltage device operably connected to at least one of the input and output of the circuit;
wherein the at least one high voltage device is partitioned from the circuit and made from a different semiconductor substrate than the core circuit.

21. The system of claim 20, wherein the different substrate is silicon carbide.

22. The system of claim 20, wherein the different substrate is any wide bandgap material.

23. The system of claim 20, wherein the different substrate is GaN.

24. A surge protection system, comprising:
a protection circuit which provides over-current protection;
at least one high voltage input device connected to the protection circuit, the at least one high voltage input device providing over-voltage protection;
at least one gate voltage enhancement circuit in series with a gate of the high voltage input device;
wherein the high voltage device is separated from the protection circuit.

25. The system of claim 24, wherein the at least one gate voltage enhancement device comprises one or more clamping devices, and wherein the at least one high voltage input device has lower pinch-off voltage than devices of the protection circuit.

26. The system of claim 25, wherein the one or more clamping devices comprise one or more selected from the group consisting of: zener diode and avalanche diode.

27. The system of clam 24, wherein a breakdown voltage of the clamping device raises the pinch-off voltage of the high voltage device to ensure stability of operation during disconnection operation.

28. The system of claim 24, wherein the breakdown voltage of the clamping device raises the pinch-off voltage of the high voltage device above that of an NMOSFET device in the protection circuit.

29. A surge protection system, comprising:
a plurality of depletion mode devices in series;
wherein two or more depletion mode devices of the plurality are n-channel high voltage devices;
wherein one or more depletion mode devices of the plurality are n-channel medium or low voltage devices; and
wherein one or more depletion mode devices of the plurality are p-channel medium or low voltage depletion mode devices;
wherein the n- and p-channel medium or low voltage depletion mode devices of the plurality are formed in a first substrate; and
wherein the two or more high voltage depletion mode devices of the plurality are formed in a second substrate.

30. The system of claim 29, wherein a medium voltage p-channel depletion mode device of the plurality has a higher pinch off voltage than a medium voltage n-channel depletion mode device of the plurality.

31. The system of claim 29, wherein a p-channel depletion mode device of the plurality has a channel in the same region as a p-body channel region of an NMOS depletion mode device of the plurality.
